(19) United States
(12) Patent Application Publication
(10) Pub. No.: US 2005/0069000 A1
(43) Pub. Date: Mar. 31, 2005

(54) Dividing method and apparatus for sheet-shaped workpiece

(76) Inventors: Yusuke Nagai, Tokyo (JP); Satoshi Kobayashi, Tokyo (JP); Yukio Morishige, Tokyo (JP)

Correspondence Address: SMITH, GAMBRELL & RUSSELL, LLP, 1850 M STREET, N.W., SUITE 800, WASHINGTON, DC, 20036, US

(21) Appl. No.: 10/943,987

(22) Filed: Sep. 20, 2004

(30) Foreign Application Priority Data
Sep. 26, 2003 (JP) 2003-334936

(51) Int. Cl. H01S 3/10

(52) U.S. Cl. 372/25; 219/121.6

(57) ABSTRACT

A dividing method and apparatus which apply a pulse laser beam capable of passing through a sheet-shaped workpiece to the workpiece, and move the workpiece and the pulse laser beam relative to each other along a division line of the workpiece. The repetition frequency Y (Hz) of the pulse laser beam is set at 200 kHz or more. The following conditions are set:
0.8≦V/(Y×D)≦2.5 where D (mm) is the spot diameter of the pulse laser beam, and V (mm/second) is the relative moving speed of the workpiece and the pulse laser beam.

### FIELD OF THE INVENTION

This invention relates to a method and apparatus for dividing a sheet-shaped workpiece, such as a semiconductor wafer, by use of a pulse laser beam.

### DESCRIPTION OF THE PRIOR ART

In the production of a semiconductor wafer, for example, it is well known that the face of a semiconductor wafer including a substrate, such as a silicon substrate, is partitioned into many rectangular regions by many streets, namely, division lines arranged in a lattice pattern, and a circuit is formed in each of the rectangular regions. Then, the semiconductor wafer is divided along the division lines to form each of the rectangular regions into a semiconductor circuit. A mode utilizing a pulse laser beam is proposed for dividing the semiconductor wafer along the division lines.

U.S. Pat. No. 6,211,488 and Japanese Patent Application Laid-Open No. 2001-277163 each disclose a dividing method and apparatus which apply a pulse laser beam to a sheet-shaped workpiece, move the workpiece and the pulse laser beam relative to each other along the division line of the workpiece, thereby generating a deterioration region in the workpiece along the division line, and then exert an external force on the workpiece to break the workpiece along the division line.

With the above-described conventional dividing method and apparatus utilizing a pulse laser beam, however, it is often the case that the workpiece cannot be divided along the division line fully precisely and sufficiently easily. If the external force, which has to be exerted on the workpiece, is great, in particular, it has been found that chipping is often caused during breakage of the workpiece, or the breakage of the workpiece often deviates from the division line.

### SUMMARY OF THE INVENTION

It is a principal object of the present invention, therefore, to improve a dividing method and apparatus for a sheet-shaped workpiece, which utilize a pulse laser beam, so that a deterioration region sufficiently decreased in breakage strength can be formed along a division line, and the workpiece can be divided along the division line fully precisely and sufficiently easily.

We, the inventors, diligently conducted studies and experiments with particular attention to the relationship between the conditions for application of a pulse laser beam and the breakage strength of the deterioration region. As a result, we found that the above-mentioned principal object can be attained by setting the repetition frequency Y (Hz) of the pulse laser beam, which is applied to a sheet-shaped workpiece, at 200 kHz or more.

According to an aspect of the present invention, there is provided, as a dividing method for a sheet-shaped workpiece, which can attain the aforementioned principal object, a dividing method comprising applying a pulse laser beam capable of passing through a sheet-shaped workpiece to the workpiece, and moving the workpiece and the pulse laser beam relative to each other along a division line of the workpiece, wherein the repetition frequency Y (Hz) of the pulse laser beam is set at 200 kHz or more.

According to another aspect of the present invention, there is provided, as a dividing apparatus for a sheet-shaped workpiece, which can attain the aforementioned principal object, a dividing apparatus comprising holding means for holding a sheet-shaped workpiece, pulse laser beam application means for applying a pulse laser beam capable of passing through the workpiece to the workpiece held by the holding means, and moving means for moving the holding means and the pulse laser beam relative to each other along a division line of the workpiece, wherein
the repetition frequency Y (Hz) of the pulse laser beam is set at 200 kHz or more.

It is preferred that the following conditions are set:
0.8≦V/(Y×D)≦2.5, particularly 1.0≦V/(Y×D)≦2.0, more particularly 1.2≦V/(Y×D)≦1.8
where Y (Hz) is the repetition frequency of the pulse laser beam, D (mm) is the spot diameter of the pulse laser beam, and V (mm/second) is the relative moving speed of the workpiece and the pulse laser beam.

In the method and apparatus of the present invention, as will be described in further detail, a required deterioration region extending substantially continuously along the division line is generated. Thus, the workpiece can be divided along the division line fully precisely and sufficiently easily.

### BRIEF DESCRIPTION OF THE DRAWINGS

FIG. 1 is a perspective view showing the essential parts of a preferred embodiment of a dividing apparatus constructed in accordance with the present invention.

FIG. 2 is a perspective view showing a state in which a semiconductor wafer, which is an example of a workpiece, is mounted on a frame.

FIG. 3 is a schematic diagram showing pulse laser application means.

FIG. 4 is a schematic view for illustrating the spot diameter of a pulse laser beam.

FIG. 5 is a partial sectional view showing a state in which the pulse laser beam is applied to the semiconductor wafer to generate a deterioration region along a division line.

FIG. 6 is a schematic view showing the arrangement of spots applied to the semiconductor wafer when a coefficient k is 1.

FIG. 7 is a schematic view showing the arrangement of spots applied to the semiconductor wafer when the coefficient k is less than 1.

FIG. 8 is a schematic view showing the arrangement of spots applied to the semiconductor wafer when the coefficient k exceeds 1.

FIG. 9 is a graph showing changes in an external force required for the breakage of the workpiece according to fluctuations in the repetition frequency of the pulse laser beam.

FIG. 10 is a graph showing changes in an external force required for the breakage of the workpiece according to fluctuations in the coefficient k.

### DETAILED DESCRIPTION OF THE PREFERRED EMBODIMENTS

Preferred embodiments of the dividing method and apparatus according to the present invention will now be described in greater detail by reference to the accompanying drawings.

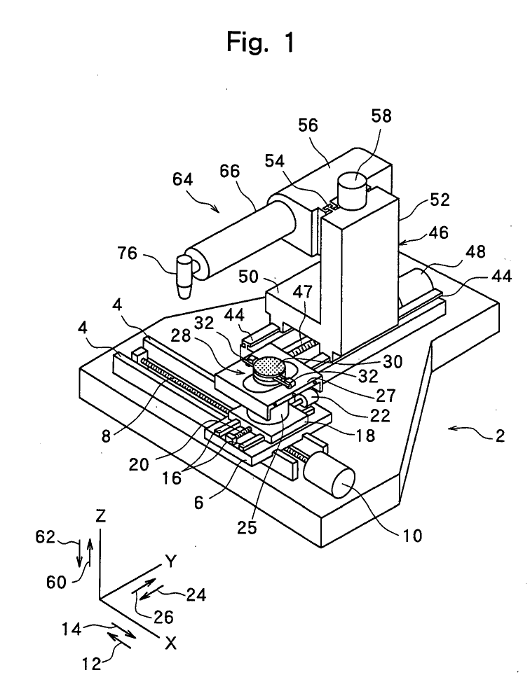

FIG. 1 shows the essential parts of a preferred embodiment of a dividing apparatus constructed in accordance with the present invention. The illustrated dividing apparatus has a support base 2, and a pair of guide rails 4 extending in an X-axis direction are disposed on the support base 2. A first slide block 6 is mounted on the guide rails 4 so as to be movable in the X-axis direction. A threaded shaft 8 extending in the X-axis direction is rotatably mounted between the pair of guide rails 4, and an output shaft of a pulse motor 10 is connected to the threaded shaft 8. The first slide block 6 has a downward portion (not shown) extending downwardly, and an internally threaded hole piercing in the X-axis direction is formed in the downward portion. The threaded shaft 8 is screwed to the internally threaded hole. Thus, when the pulse motor 10 is rotated in a normal direction, the first slide block 6 is moved in a direction indicated by an arrow 12. When the pulse motor 10 is rotated in a reverse direction, the first slide block 6 is moved in a direction indicated by an arrow 14. As will become apparent from descriptions to be offered later, the pulse motor 10 and the threaded shaft 8 rotated thereby constitute moving means for moving a workpiece (relative to pulse laser beam application means).

A pair of guide rails 16 extending in a Y-axis direction are disposed on the first slide block 6. A second slide block 18 is mounted on the guide rails 16 so as to be movable in the Y-axis direction. A threaded shaft 20 extending in the Y-axis direction is rotatably mounted between the pair of guide rails 16, and an output shaft of a pulse motor 22 is connected to the threaded shaft 20. An internally threaded hole piercing in the Y-axis direction is formed in the second slide block 18, and the threaded shaft 20 is screwed to the internally threaded hole. Thus, when the pulse motor 22 is rotated in a normal direction, the second slide block 18 is moved in a direction indicated by an arrow 24. When the pulse motor 22 is rotated in a reverse direction, the second slide block 18 is moved in a direction indicated by an arrow 26. A support table 27 is fixed to the second slide block 18 via a cylindrical member 25, and holding means 28 is also mounted on the second slide block 18 via the cylindrical member 25. The holding means 28 is mounted so as to be rotatable about a central axis extending substantially vertically. A pulse motor (not shown) for rotating the holding means 28 is disposed within the cylindrical member 25. The holding means 28 in the illustrated embodiment is composed of a chuck plate 30 formed from a porous material, and a pair of gripping means 32.

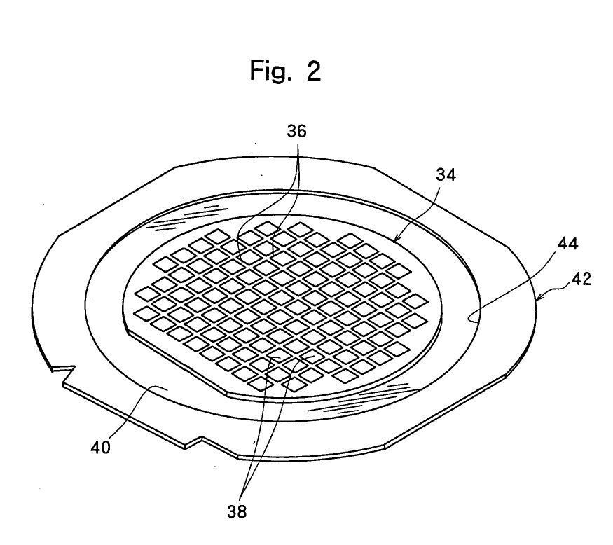

FIG. 2 shows a semiconductor wafer 34 which is a workpiece. The semiconductor wafer 34 is composed of a silicon substrate, and streets, i.e., division lines 36 are arranged in a lattice pattern on the face of the semiconductor wafer 34. A plurality of rectangular regions 38 are demarcated by the division lines 36. A semiconductor circuit is formed in each of the rectangular regions 38. In the illustrated embodiment, the semiconductor wafer 34 is mounted on a frame 42 via a mounting tape 40. The frame 42, which can be formed from a suitable metal or synthetic resin, has a relatively large circular opening 44 at the center, and the semiconductor wafer 34 is positioned in the opening 44. The mounting tape 40 extends on lower surfaces of the frame 42 and the semiconductor wafer 34 across the opening 44 of the frame 42, and is stuck to the lower surfaces of the frame 42 and the semiconductor wafer 34. In applying a pulse laser beam to the semiconductor wafer 34, the semiconductor wafer 34 is located on the chuck plate 30 in the holding means 28, and the chuck plate 30 is brought into communication with a vacuum source (not shown), whereby the semiconductor wafer 34 is vacuum attracted onto the chuck plate 30. The pair of gripping means 32 of the holding means 28 grip the frame 42. The holding means 28 itself, and the semiconductor wafer 34 itself mounted on the frame 42 via the mounting tape 40 may be in forms well known among people skilled in the art, and thus detailed explanations for them will be omitted herein. Particularly when a metal film (so-called teg film) or a low dielectric constant insulating film (so-called low-k film) is formed on the division lines 36 on the face of the semiconductor wafer 34, it is advantageous that the semiconductor wafer 34 is mounted on the frame 42, with the face and back of the semiconductor wafer 34 being inverted (thus, the pulse laser beam is applied to the back of the semiconductor wafer 34).

Referring to FIG. 1 again, a pair of guide rails 44 extending in the Y-axis direction are disposed on the support base 2. A third slide block 46 is mounted on the pair of guide rails 44 so as to be movable in the Y-axis direction. A threaded shaft 47 extending in the Y-axis direction is rotatably mounted between the pair of guide rails 44, and an output shaft of a pulse motor 48 is connected to the threaded shaft 47. The third slide block 46 is nearly L-shaped, and has a horizontal base portion 50, and an upright portion 52 extending upwardly from the horizontal base portion 50. The horizontal base portion 50 has a downward portion (not shown) extending downwardly, and an internally threaded hole piercing in the Y-axis direction is formed in the downward portion. The threaded shaft 47 is screwed to the internally threaded hole. Thus, when the pulse motor 48 is rotated in a normal direction, the third slide block 46 is moved in the direction indicated by the arrow 24. When the pulse motor 48 is rotated in a reverse direction, the third slide block 46 is moved in the direction indicated by the arrow 26.

A pair of guide rails 54. (only one of them is shown in FIG. 1) extending in a Z-axis direction are disposed on one side surface of the upright portion 52 of the third slide block 46. A fourth slide block 56 is mounted on the pair of guide rails 54 so as to be movable in the Z-axis direction. A threaded shaft (not shown) extending in the Z-axis direction is rotatably mounted on one side surface of the third slide block 46, and an output shaft of a pulse motor 58 is connected to the threaded shaft. A protrusion (not shown) projecting toward the upright portion 52 is formed in the fourth slide block 56, and an internally threaded hole piercing in the Z-axis direction is formed in the protrusion. The above-mentioned threaded shaft is screwed to this internally threaded hole. Thus, when the pulse motor 58 is rotated in a normal direction, the fourth slide block 56 is moved in a direction indicated by an arrow 60, namely, is moved upward. When the pulse motor 58 is rotated in a reverse direction, the fourth slide block 56 is moved in a direction indicated by an arrow 62, namely, is moved downward.

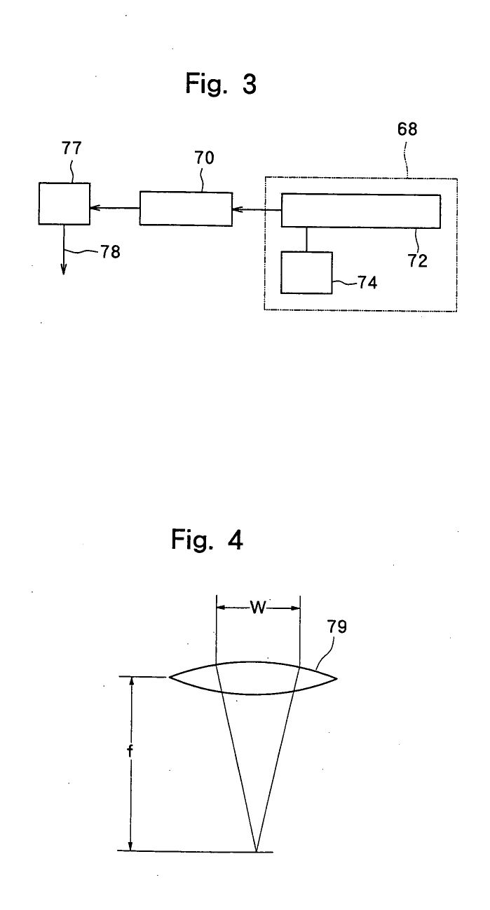

Pulse laser beam application means, indicated entirely at a numeral 64, is mounted on the fourth slide block 56. The illustrated pulse laser beam application means 64 includes a casing 66 of a cylindrical shape fixed to the fourth slide block 56 and extending forward (i.e., in the direction indicated by the arrow 24) substantially horizontally. Further with reference to FIG. 3 along with FIG. 1, pulse laser beam oscillation means 68 and a transmission optical system 70 are disposed within the casing 66. The oscillation means 68 is composed of an laser oscillator 72, which is advantageously a YAG laser oscillator or a YVO4 laser oscillator, and a repetition frequency setting means 74 annexed thereto. The transmission optical system 70 includes a suitable optical element such as a beam splitter. An applicator head 76 is fixed to the front end of the casing 66, and a focusing optical system 77 is disposed within the applicator head 76.

A pulse laser beam 78 oscillated by the oscillation means 68 arrives at the focusing optical system 77 via the transmission optical system 70, and is applied from the focusing optical system 77 to the semiconductor wafer 34, which is held on the holding means 28, with a predetermined spot diameter D. The spot diameter D of the pulse laser beam 78 applied to the semiconductor wafer 34 is defined as D (μm)=4×λ×f/(π×W), where λ is the wavelength (μm) of the pulse laser beam 78, W is the diameter (mm) of the pulse laser beam 78 incident on an objective lens 79, and f is the focal length (mm) of the objective lens 79, for example, if the pulse laser beam 78 showing a Gaussian distribution is applied to the semiconductor wafer 34 through the objective lens 79, as shown in FIG. 4.

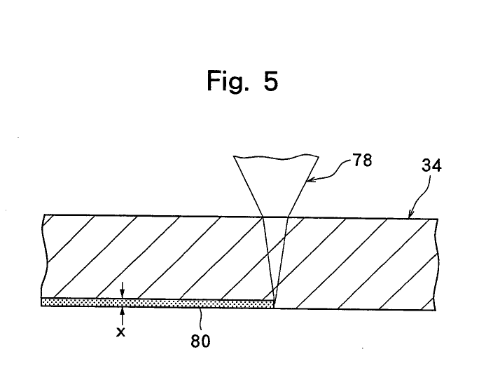

With reference to FIG. 5 along with FIG. 1, the pulse laser beam 78 is applied to the semiconductor wafer 34 at the site of the division line 36. Assume that the pulse laser beam 78, which passes through the semiconductor wafer 34, is applied to the back of the semiconductor wafer 34 or its vicinity, for example, as shown in FIG. 5. In this case, the semiconductor wafer 34 is deteriorated in a zone of a thickness x, starting at the back of the semiconductor wafer 34. This deterioration depends on the substrate material of the semiconductor wafer 34, and the peak power density of the pulse laser beam 78, and normally appears as melting of the material. Thus, when the semiconductor wafer 34 is moved along the division line 36 by moving the holding means 28, which holds the semiconductor wafer 34, in the direction indicated by the arrow 12 (or 14), a deterioration region 80 extending with the thickness x along the division line 36 is generated in the semiconductor wafer 34. In the deterioration region 80, the material is melted by the application of the pulse laser beam 78, and the material is resolidified after completion of application of the pulse laser beam 78. Normally, in such a deterioration region 80, the strength of the material is locally decreased. Thus, the semiconductor wafer 34 can be broken along the division line 36 by exerting a suitable external force on the semiconductor wafer 34. If desired, the fourth slide block 56, to which the pulse laser beam application means 64 is fixed, is moved, for example by the thickness x, in the direction indicated by the arrow 60 to raise the focus spot position of the pulse laser beam 78 by the thickness x. Then, the semiconductor wafer 34 and the pulse laser beam 78 are moved again along the division line 36, whereby the thickness of the deterioration region 80 is rendered 2×x. Alternatively, the raising of the pulse laser beam 78, and the movement of the semiconductor wafer 34 along the division line 36 are further repeated, whereby the thickness of the deterioration region 80 can be further increased. If desired, the deterioration region 80 can be generated throughout the substrate thickness of the semiconductor wafer 34. In the illustrated embodiment, the semiconductor wafer 34 is moved, whereby the semiconductor wafer 34 and the pulse laser beam 78 are moved relative to each other along the division line 36. Instead of, or in addition to, this mode, the pulse laser beam 78 is moved, whereby the semiconductor wafer 34 and the pulse laser beam 78 can be moved relative to each other along the division line 36. In the illustrated embodiment, moreover, the pulse laser beam 78 is raised (or lowered) to move the focus spot position of the pulse laser beam 78 relatively in the thickness direction of the semiconductor wafer 34. Instead of, or in addition to, this mode, the semiconductor wafer 34 is moved in its thickness direction, whereby the focus spot position of the pulse laser beam 78 can be moved relatively in the thickness direction of the semiconductor wafer 34.

In the present invention, it is important to set the repetition frequency Y (Hz) of the pulse laser beam 78 at 200 kHz or more. If the repetition frequency Y of the pulse laser beam 78 exceeds 200 kHz, the external force, which has to be exerted on the semiconductor wafer 34 when breaking the semiconductor 34 along the division line 36 running along the resulting deterioration region 80, can be rendered a sufficiently low value, as will be clearly understood from Experimental Example 1 to be described later. Thus, the semiconductor wafer 34 can be divided along the division line 36 sufficiently easily and fully precisely.

The theoretical reason for the importance of setting the repetition frequency Y of the pulse laser beam 78 at 200 kHz or more is not entirely clear. However, we speculate that this setting may result in a so-called heat storage effect. In detail, the generation of deterioration due to application of the pulse laser beam 78 occurs by the mechanism that the semiconductor wafer 34 is locally and instantaneously heated and melted by absorbing the pulse laser beam, and is then resolidified upon natural cooling. This heating is instantaneous, while the cooling takes some time. If the repetition frequency Y of the pulse laser beam 78 is high, the time interval between the pulses is short, so that during cooling, the application of the pulse laser beam 78 is repeated. As a result, the temperature at the site of application of the pulse laser beam 78 gradually rises, reaching a predetermined temperature which represents a steady state. Consequently, melting is caused effectively, with the result that the generation of deterioration due to melting and resolidification is achieved effectively. If the repetition frequency Y of the pulse laser beam 78 is low, on the other hand, a next pulse laser beam 78 is applied after cooling has considerably proceeded. Thus, the temperature at the site of application of the pulse laser beam 78 is not effectively raised.

In the present invention, moreover, it is important that a coefficient k, k=V/(Y×D), defined by the repetition frequency Y (Hz) of the pulse laser beam 78, the spot diameter D (mm) of the pulse laser beam 78, and the relative moving speed V (mm/sec) of the semiconductor wafer 34, which is a workpiece, and the pulse laser beam 78 be set at 0.8 to 2.5, preferably 1.0 to 2.0, particularly preferably 1.2 to 1.8. In other words, it is important that the relationship among the repetition frequency Y, the spot diameter D, and the relative moving speed V be set to be 0.8≦V/(Y×D)≦2.5, preferably 1.0≦V/(Y×D)≦2.0, particularly preferably 1.2≦V/(Y×D)≦1.8.

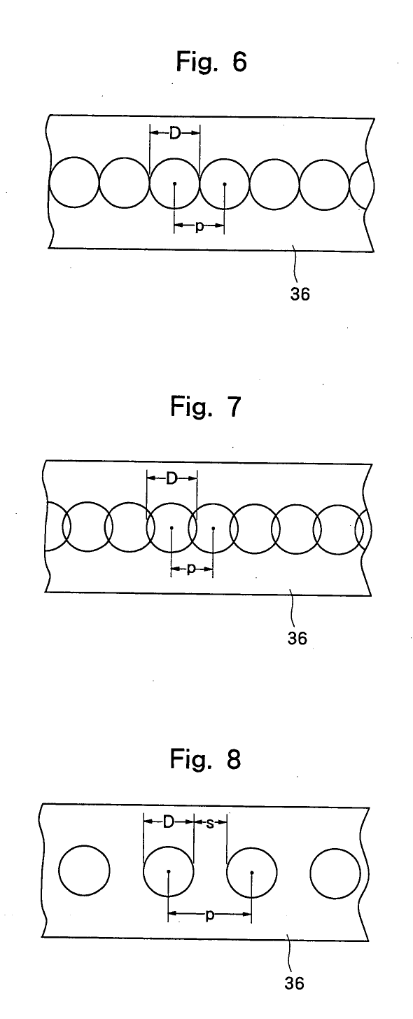

In further detail, when the pulse laser beam 78 of the repetition frequency Y is applied to the semiconductor wafer 34 with the spot diameter D, and the semiconductor wafer 34 and the pulse laser beam 78 are relatively moved along the division line 36, assume that the coefficient k is 1. In this case, as shown in FIG. 6, the pitch p of the spots of the pulse laser beam 78 is the same as the spot diameter D. Thus, the spots of the pulse laser beam 78 are applied, in contact with each other (namely, without overlapping and without having no clearance therebetween), continuously along the division line 36. If the coefficient k is less than 1, as shown in FIG. 7, the spots of the pulse laser beam 78 are applied, while overlapping each other, continuously along the division line 36. If the coefficient k is greater than 1, as shown in FIG. 8, the spots of the pulse laser beam 78 are applied, with a clearance being interposed between the adjacent spots, continuously along the division line 36. If the coefficient k is 2, the spacing s between the adjacent spots equals D. To divide the semiconductor wafer 34 along the division line 36 fully precisely and sufficiently easily, it is important to set the coefficient k at 0.8 to 2.5, preferably 1.0 to 2.0, particularly preferably 1.2 to 1.8. The reason for this is not entirely clear, but we speculate as follows: If the coefficient k is too large, accordingly, if the clearance between the adjacent spots is excessively large, a non-deterioration zone remains between the spots. Hence, non-deterioration zones, which are not weakened, are left interruptedly along the division line 36. Owing to such non-deterioration zones, an excessive external force is required for breakage along the division line 36, or breakage deviates from the division line 36 at the sites of the unweakened zones. If the coefficient k is too small, on the other hand, the zones, which are heated and deteriorated by the application of the pulse laser beam 78 and then cooled, are heated by reapplication of the pulse laser beam 78. As a result, an effect such as that of quenching in a metal is produced. Thus, the zones, whose breakage strength is not decreased, but increased, are generated. Owing to such strength-increased zones, an excessive external force is required for breakage along the division line 36, or breakage deviates from the division line 36 at the sites of the strength-increased zones. If the coefficient k is 0.8 to 2.5, particularly 1.0 to 2.0, especially 1.2 to 1.8, when a deterioration zone is to be newly generated adjacent to the already deteriorated zone, the occurrence of deterioration extends from the already deteriorated zone to the zone to be newly deteriorated, by being induced by the high temperature of the zone to be newly deteriorated. The region, which has been so deteriorated and decreased in breakage strength, is generated substantially continuously along the division line 36, without a non-deterioration zone being interposed and without a strength-increased zone being generated.

### EXPERIMENTAL EXAMPLE 1

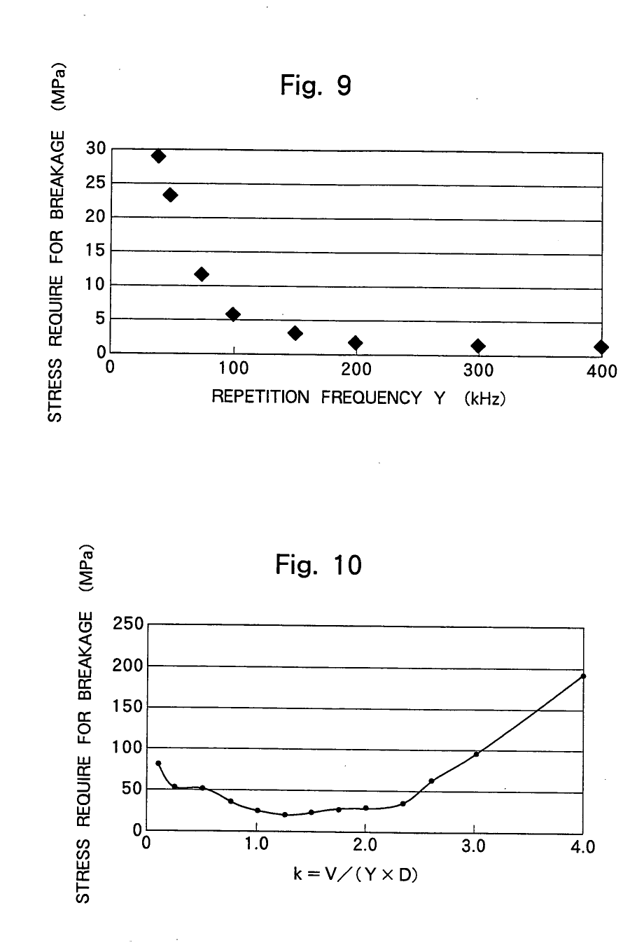

Using a dividing apparatus of a form as shown in FIG. 1, a pulse laser beam was applied to a semiconductor wafer along a division line extending straightly. The semiconductor wafer was formed of silicon, its edges other than straight edges, called orientation flats, were arcuate with a diameter of 8 inches, and the thickness was 600 μ. Oscillation means of pulse laser beam application means was a YVO4 pulse laser oscillator, which had a wavelength of 1,064 nm and a pulse energy of 10 μJ. The diameter of the focus spot, namely, the spot diameter D, was 1 μm, and the energy density of the focus spot was 1.0×10¹⁰ W/cm² or more. The focus spot of the pulse laser beam was located at the back of the semiconductor wafer, and the semiconductor wafer was moved along the division line. In this manner, a deterioration region was generated along the division line at a site of about 60 μm thick, starting at the back of the semiconductor wafer. Further, focus spot raising for raising the focus spot by 60 μm, and semiconductor wafer movement for moving the semiconductor wafer along the division line were repeated 9 times (accordingly, this procedure was performed a total of 10 times). By so doing, the deterioration region was generated along the division line throughout the thickness of the semiconductor wafer. The repetition frequency Y of the pulse laser beam was varied in the range of 40 kHz to 400 kHz and, in order to maintain the coefficient k=V/(Y×D) at 1, the moving speed V of the semiconductor wafer was varied in the range of 40 mm/second to 400 mm/second in accordance with fluctuations in the repetition frequency Y of the pulse laser beam. Stress required for breaking the semiconductor wafer along the division line was measured in each of these cases. Measurement of the stress was performed by supporting the back of the semiconductor wafer along the division line at sites 2.0 mm spaced from both sides of the division line, and imposing a load on the face of the semiconductor wafer along the division line. The stress measured was based on the load imposed when the semiconductor wafer was broken. The results of the measurements are shown in FIG. 9. It is understood that if the repetition frequency Y of the pulse laser beam exceeds 200 kHz, the required external force becomes sharply decreased.

### EXPERIMENTAL EXAMPLE 2

The repetition frequency of the pulse laser beam was fixed at 100 kHz (the repetition frequency Y of the pulse laser beam was set intentionally at 100 kHz, rather than 200 kHz or more, in order to confirm the influence of fluctuations in the coefficient k), and the moving speed V of the semiconductor wafer was varied in the range of 10 to 400 mm/second, accordingly, the coefficient k was varied in the range of 0.1 to 4.0. With these exceptions, stress required for breaking the semiconductor wafer along the division line was measured in each of the cases in the same manner as in Experimental Example 1. The results of the measurements are shown in FIG. 10. It is understood that when the coefficient k is 0.8 to 2.5, particularly 1.0 to 2.0, more particularly 1.2 to 1.8, an external force required for breakage of the semiconductor wafer is small.

1. A dividing method comprising applying a pulse laser beam capable of passing through a sheet-shaped workpiece to said workpiece, and moving said workpiece and said pulse laser beam relative to each other along a division line of said workpiece, wherein
a repetition frequency Y (Hz) of said pulse laser beam is set at 200 kHz or more.

2. The dividing method according to claim 1, wherein the following conditions are set:
0.8≦V/(Y×D)≦2.5
where D (mm) is a spot diameter of said pulse laser beam, and V (mm/second) is a relative moving speed of said workpiece and said pulse laser beam.

3. The dividing method according to claim 2, wherein the following conditions are set:
1.0≦V/(Y×D)≦2.0

4. The dividing method according to claim 3, wherein the following conditions are set:
1.2≦V/(Y×D)≦1.8

5. A dividing apparatus comprising holding means for holding a sheet-shaped workpiece, pulse laser beam application means for applying a pulse laser beam capable of passing through said workpiece to said workpiece held by said holding means, and moving means for moving said holding means and said pulse laser beam relative to each other along a division line of said workpiece, wherein
a repetition frequency Y (Hz) of said pulse laser beam is set at 200 kHz or more.

6. The dividing apparatus according to claim 5, wherein the following conditions are set:
0.8≦V/(Y×D)≦2.5
where D (mm) is a spot diameter of said pulse laser beam, and V (mm/second) is a relative moving speed of said workpiece and said pulse laser beam.

7. The dividing apparatus according to claim 6, wherein the following conditions are set:
1.0≦V/(Y×D)≦2.0.

8. The dividing apparatus according to claim 7, wherein the following conditions are set:
1.2≦V/(Y×D)≦1.8.
